(19) United States
(12) Patent Application Publication
(10) Pub. No.: US 2025/0302681 A1
(43) Pub. Date: Oct. 2, 2025

(54) Multi-Speed Ergonomic Wheelchair And Devices And Methods Therefor

(71) Applicants: United States Government as Represented by the Department of Veterans Affairs, Washington, DC (US); Regents of the University of Minnesota, St. Paul, MN (US)

(72) Inventors: Andrew Hansen, Apple Valley, MN (US); Gregory Owen Voss, Apple Valley, MN (US); Eric Nickel, Minneapolis, MN (US); Gary Goldish, Plymouth, MN (US); John M. Looft, Minneapolis, MN (US)

(21) Appl. No.: 19/236,658

(22) Filed: Jun. 12, 2025

Related U.S. Application Data
(63) Continuation of application No. 17/684,990, filed on Mar. 2, 2022.
(60) Provisional application No. 63/155,544, filed on Mar. 2, 2021.

(51) Int. Cl. A61G 5/02; F16H 1/28; F16H 7/02; F16H 7/06

(52) U.S. Cl. CPC A61G 5/022; A61G 5/026; F16H 7/02; F16H 7/06; F16H 1/28

(57) ABSTRACT

A wheelchair having a frame and a drive wheel coupled to the frame. The drive wheel rotates relative to the frame about a first axis of rotation. A first push rim is coupled to the frame. The first push rim rotates relative to the frame about a second axis of rotation that extends substantially parallel to the first axis of rotation. A second push rim is coupled to the frame. The second push rim rotates relative to the frame about a third axis of rotation that extends substantially parallel to the first axis of rotation. A transmission transmits rotation of each of the first and second push rims to the drive wheel. Movement of the first push rim by a first arc length causes the drive wheel to rotate by a first angular displacement, and movement of the second push rim by the first arc length causes the drive wheel to rotate by a second angular displacement that is greater than the first angular displacement.

### CROSS-REFERENCE TO RELATED APPLICATION

The application is a continuation of U.S. application Ser. No. 17/684,990, filed Mar. 2, 2022, which claims priority to and the benefit of the filing date of U.S. Provisional Patent Application No. 63/155,544, filed Mar. 2, 2021, the entirety of each of which is hereby incorporated by reference herein.

### FIELD

The application is generally related to wheelchairs and, in particular, to assemblies for propelling the wheelchair.

### BACKGROUND

The most common form of a manual wheelchair 100 utilizes a push rim 110 connected directly to the drive wheels 120 as shown in FIG. 1. The wheelchair user is able to propel the wheelchair 100 by pushing the push rims 110 with her hands, thereby rotating the wheel an equal angle and translating the chair forward. The common wheelchair is elegant in its simplicity. However, the inherent mechanical coupling of the push rim 110 and the wheel 120 require that they be placed in the same fore-aft position, which may lead to reduced stability of the wheelchair and/or shoulder problems. In setup of the common wheelchair, the clinician must balance concerns of shoulder biomechanics and stability of the wheelchair. On one hand, the clinician would like to move the push rims forward to promote a better positioning of the shoulders for propulsion. On the other hand, the axle of the wheels 120 must remain behind the center of gravity 130 to reduce the likelihood the wheelchair 100 will tip over backward. A common approach is to move the push rim/wheel combination 110/120 as far forward as possible while still maintaining a stable base 150 of support of the wheelchair by positioning the drive wheel 120 and front casters 140 to frame the center of gravity 130 in fore/aft directions.

The positioning of the push-rim/wheel 110/120 combination in common wheelchairs leads to difficulties in transfers (transferring in and out of the wheelchair 100). For example, the user must position the wheelchair at an angle with a bed 200 or other transfer surface in order to use a transfer board 210 (see FIG. 2). Without a transfer board, the person must elevate her body a significant distance to clear the wheel of the wheelchair (FIGS. 3A, 3B).

Moreover, conventional wheelchairs comprise a single push rim on each side that is coupled to the respective drive wheel at a fixed gear ratio. Accordingly, a balance must be set between the force required to push the single push rim and the number of revolutions of the single push rim. In order to keep the force required to push the push rim in a manageable range to allow the user to push the wheelchair uphill and across difficult terrain, the wheelchair is typically configured with a push rim that requires a significantly high number of rotations for movement across easy flat terrain. This can lead to excessive arm movement cycles that, over time, can lead to injury of the user (often to her shoulders).

Some manual wheelchairs have been adapted with specialized wheels which add a gear between the tire and hand rim in order to allow shifting between normal gear ratio to lower gear for going up inclines or rough terrain, but the wheelchair must be stopped to change gears. Stopping to change gears results in loss of momentum of the wheelchair. Thus, the user is required to restart the wheelchair from a full stop, with resultant loss of efficiency.

### SUMMARY

Described herein, in various aspects, is a wheelchair comprising a frame and a drive wheel coupled to the frame. The drive wheel can be configured to rotate relative to the frame about a first axis of rotation. A first push rim can be coupled to the frame. The first push rim can be configured to rotate relative to the frame about a second axis of rotation that extends parallel or substantially parallel to the first axis of rotation. A second push rim can be coupled to the frame. The second push rim can be configured to rotate relative to the frame about a third axis of rotation that extends parallel or substantially parallel to the first axis of rotation. A transmission can be configured to transmit rotation of each of the first and second push rims to the drive wheel to effect rotation of the drive wheel. Movement of the first push rim by a first arc length can be configured to cause the drive wheel to rotate by a first angular displacement, and movement of the second push rim by the first arc length is configured to cause the drive wheel to rotate by a second angular displacement that is greater than the first angular displacement.

Additional advantages will be set forth in part in the description that follows, and in part will be obvious from the description, or may be learned by practice of the disclosed wheelchair, systems, and/or methods. The advantages will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION OF THE DRAWINGS

These and other features of the preferred embodiments of the disclosed wheelchair, systems, and methods will become more apparent in the detailed description in which reference is made to the appended drawings wherein:

FIG. 1 is a diagram illustrating an example wheelchair.

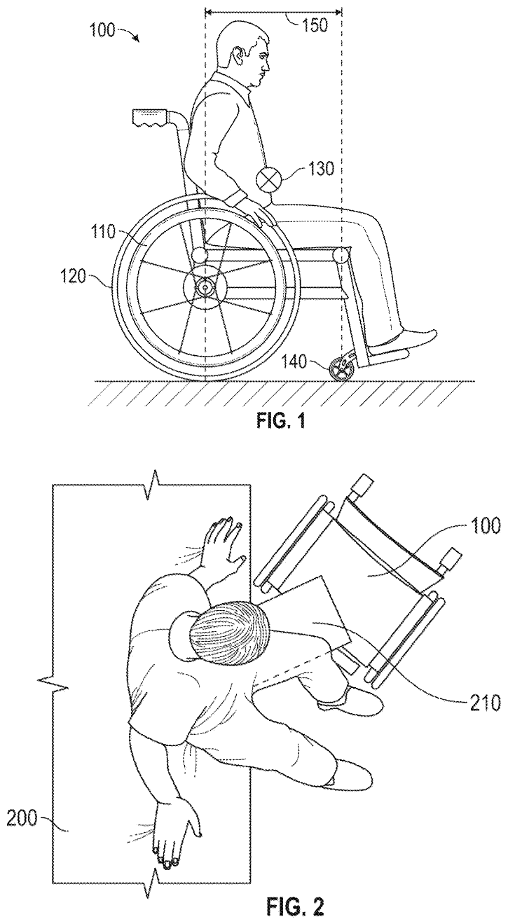

FIG. 2 is a diagram illustrating an example wheelchair transfer with a transfer board.

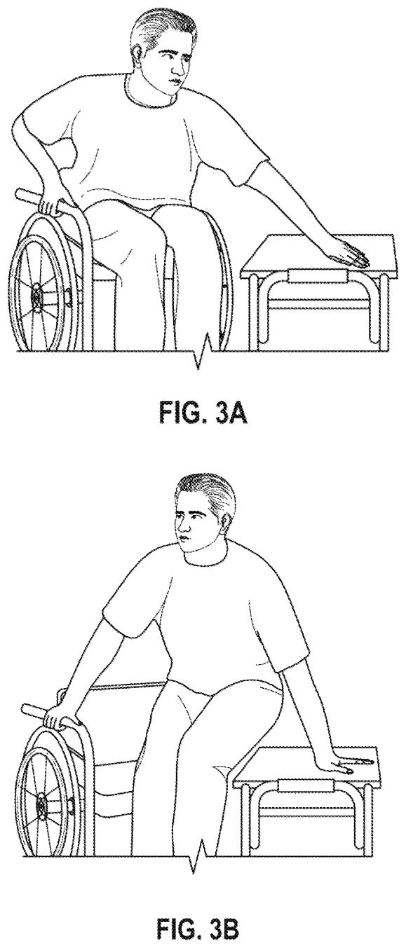

FIGS. 3A and 3B are diagrams illustrating an example wheelchair transfer without a transfer board.

FIGS. 4A-4D are diagrams illustrating an example wheelchair with a push rim capable of being rotated backward and out of the way for transfers according to a first implementation of the present application.

FIGS. 5A-5D are diagrams illustrating an example wheelchair with a push rim capable of being removed and placed out of the way for transfers according to a second implementation of the present application.

FIG. 6 is a top view illustrating an example transfer of a patient from a bed to a wheelchair according to an embodiment disclosed herein.

FIGS. 7A-7B are diagrams illustrating an example wheelchair with a push rim capable of being translated backward and out of the way for transfers according to a third implementation of the present application.

FIG. 8 is a diagram illustrating a user's range of motion laid over a diagram of an example wheelchair.

FIG. 9 is a diagram illustrating a user's range of motion laid over a diagram of a wheelchair according to an implementation of the present application.

FIGS. 10A-10C are diagrams illustrating placement of a push rim at different positions along a wheelchair according to an implementation of the present application.

FIG. 11 is perspective view of a wheelchair comprising first and second push rims on each side.

FIG. 12 is a perspective view of the first and second push rims of FIG. 11, showing the first and second push rims coupled together as an assembly.

FIG. 13 is a perspective view of an epicyclic (planetary) gear system for providing gearing between the first push rim and the second push rim of FIG. 12.

FIG. 14 is an exploded perspective view of the assembly of the first and second push rims of FIG. 12.

FIG. 15 is an exploded side view of the assembly of the first and second push rims of FIG. 12.

FIG. 16 is a partially exploded side view of the assembly of the first and second push rims of FIG. 12.

FIG. 17 is a perspective view of the wheelchair of FIG. 11 with both of the first and second push rims removed.

FIG. 18 is a perspective view of the wheelchair of FIG. 11 with the second push rim removed.

FIG. 19 is a schematic diagram of first and second alternative transmissions for coupling the first and second push rims to the drive wheels, wherein the first and second alternative transmissions have different sprocket ratios.

FIG. 20 is a graph showing how varying the sprocket ratio of the transmission shifts the torque advantage of both the first and second push rims for tailoring the wheelchair for different users.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

As used herein the singular forms “a,” “an,” and “the” include plural referents unless the context clearly dictates otherwise. For example, use of the term “a wheel” can refer to one or more of such wheels, and so forth.

All technical and scientific terms used herein have the same meaning as commonly understood to one of ordinary skill in the art to which this invention belongs unless clearly indicated otherwise.

As used herein, the terms “optional” or “optionally” mean that the subsequently described event or circumstance may or may not occur, and that the description includes instances where said event or circumstance occurs and instances where it does not.

As used herein, the term “at least one of” is intended to be synonymous with “one or more of.” For example, “at least one of A, B and C” explicitly includes only A, only B, only C, and combinations of each.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedents “about,” “substantially,” or “generally,” it is contemplated that values within up to 15%, up to 10%, up to 5%, or up to 1% (above or below) of the particularly stated value can be included within the scope of those aspects. In other aspects, when angular values are approximated by use of the antecedents “about,” “substantially,” or “generally,” it is contemplated that angular values within up to 15 degrees, up to 10 degrees, up to 5 degrees, or up to one degree (above or below) of the particularly stated angular value can be included within the scope of those aspects.

The word “or” as used herein means any one member of a particular list and also includes any combination of members of that list.

In the following description and claims, wherever the word “comprise” or “include” is used, it is understood that the words “comprise” and “include” can optionally be replaced with the words “consists essentially of” or “consists of” to form another embodiment.

It is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

The following description supplies specific details in order to provide a thorough understanding. Nevertheless, the skilled artisan would understand that the apparatus, system, and associated methods of using the apparatus can be implemented and used without employing these specific details. Indeed, the apparatus, system, and associated methods can be placed into practice by modifying the illustrated apparatus, system, and associated methods and can be used in conjunction with any other apparatus and techniques conventionally used in the industry.

### Exemplary Wheelchairs

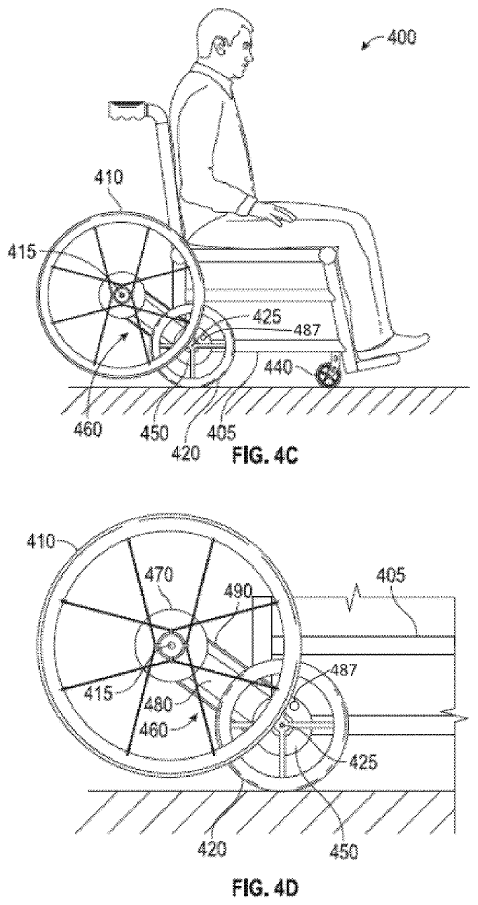

Disclosed herein, in various aspects and with reference to FIGS. 4A-4D, is an example wheelchair with a push rim capable of being rotated backward and out of the way for transfers according to a first implementation of the present application. More specifically, FIG. 4A illustrates the wheelchair with the push rim rotated forward into a propulsion position. Further, FIG. 4B illustrates an enlarged view of the push rim relocation mechanism in the propulsion position. Further, FIG. 4C illustrates the wheelchair with the push rim rotated backward into a transfer position. Further, FIG. 4D illustrates an enlarged view of the push rim relocation mechanism in the transfer position.

In this implementation, the wheelchair 400 includes a frame 405, a rotatable push rim 410 connected to the frame 405 and a drive wheel 420 connected to the frame 405. The wheelchair 400 may also include caster wheels 440 located in front of the drive wheel 420. The caster wheels 440 and the drive wheels 420 collectively form the base of support 435 of the wheelchair. In order to provide a stable ride for the user, it may be preferable that caster wheels 440 and the drive wheels be positioned such that the user's center of gravity 430 is located directly above the base of support 435, rather than in front of or behind the base of support 435.

As shown in FIGS. 4A-4D, the axis of rotation 425 of the drive wheel 420 is offset from the axis of rotation 415 of the push rim. Thus, instead of being directly coupled to each other, the push rim 410 and drive wheel 420 are connected by a transmission 460. The transmission 460 may include a drive gear/hub 450 coupled to drive wheel 420, a push rim gear/hub 470 coupled to the push rim 410, and a chain or belt 490 connected to the drive gear/hub 450 and the push rim gear/hub 470.

Thus, de-coupling the fore-aft position of the push rims 410 and drive wheels 420 may allow a clinician to place the drive wheels 420 in their optimal position to provide a stable base of support 435 while still allowing the person to do “wheelies” (e.g., with one or more wheels off the ground) if needed (to go over curbs and other thresholds). Also, the position of the push rims 410 can be set to promote the best positioning of the wheelchair user's shoulders. A potential aspect of this more forward positioning of the push rims 410 is a reduction in shoulder pain resulting from manual propulsion of the wheelchair. In other words, de-coupling of the push rims 410 and drive wheels 420 may allow the clinician to place the push rims 420 in front of the user's center of gravity 430 as shown in FIGS. 4A-4D, potentially improving mechanical efficiency without sacrificing wheelchair stability.

Additionally, the use of the transmission 460 with the belts or chains 490 may allow the wheelchair to also incorporate into one or both of the drive gear/hub 450 and the push rim gear/hub 470 a multispeed fixed-gear hub such as the Sturmey-Archer S3X fixed-gear hub. In such implementations, the ability to switch to higher or lower speeds may allow the wheelchair user to go faster on smooth/even terrain and to require less torque and forces on the shoulders to go up inclined terrain.

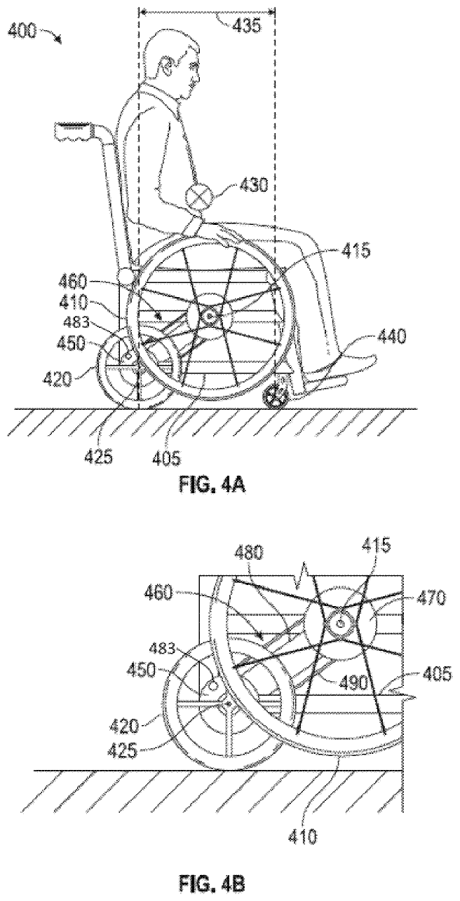

Additionally, in some implementations, the wheelchair 400 also includes a push rim repositioning member 480 that allows the push rim 410 to be repositioned to allow a user to transfer into and out of wheelchair 400 without having to lift himself over the push rim as shown in FIGS. 3A and 3B above. In FIGS. 4A-4D, the repositioning member 480 is a swing arm rotatably mounted to the frame 405 and configured to rotate about the axis of rotation 425 of the drive train. As shown, the push rim gear/hub 470 and push rim 410 are located at a first end of the swing arm 480, the drive wheel gear/hub 450 is located at a second end of the swing arm 480, and the belt/chain 490 extends along the length of the swing arm. As shown in FIGS. 4A and 4B, the swing arm 480 can be rotated forward to position the push rim 410 forward of a user's shoulders to allow the propulsion of the wheelchair by the user (known as the propulsion position). As shown in FIGS. 4C and 4D, the swing arm 480 can be rotated backward to position the push rim 410 behind a user's shoulders to allow the user to transfer into and out of the wheelchair.

Additionally, in some optional embodiments, a locking mechanism 483 may be provided to releasably hold the push rim repositioning member 480 (e.g., swing arm) in the propulsion position shown in FIGS. 4A and 4B. Further, a second locking mechanism 487 or hard stop may also be provided to releasably hold or limit the rearward rotation of the push rim repositioning member 480 (e.g., swing arm) in the transfer position shown in FIGS. 4C and 4D.

Though various aspects of this embodiment are shown in the figures and discussed above, implementations of this embodiment and application are not limited to these aspects, and, accordingly, alternative implementations are discussed below.

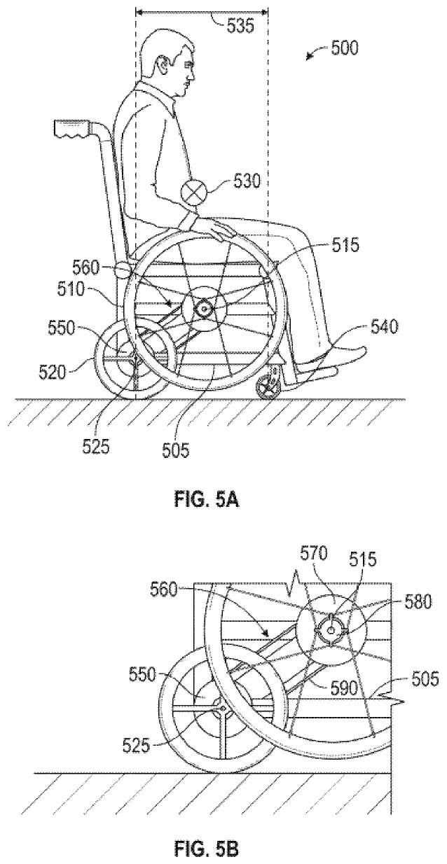

FIGS. 5A-5D are diagrams illustrating an example wheelchair with a push rim capable of being removed and placed out of the way for transfers according to a second implementation of the present application. More specifically, FIG. 5A illustrates the wheelchair with the push rim attached to the wheelchair in a propulsion position. Further, FIG. 5B illustrates an enlarged view of the push rim relocation mechanism with the push rim attached in the propulsion position. Further, FIG. 5C illustrates the wheelchair with the push rim disconnected from the wheelchair and repositioned for a transfer. Further, FIG. 5D illustrates an enlarged view of the push rim removed for a transfer.

As with the implementation discussed above, in this implementation, the wheelchair 500 includes a frame 505, a rotatable push rim 510 connected to the frame 505, and a drive wheel 520 connected to the frame 505. The wheelchair 500 may also include caster wheels 540 located in front of the drive wheel 520. Again, the caster wheels 540 and the drive wheels 520 collectively form the base of support 535 of the wheelchair. In order to provide a stable ride for the user, it may be preferable that caster wheels 540 and the drive wheels 520 be positioned such that the user's center of gravity 530 is located directly above the base of support 535, rather than in front of or behind the base of support 535.

As shown in FIGS. 5A-5D, the axis of rotation 525 of the drive wheel 520 is offset from the axis of rotation 515 of the push rim 510. Thus, instead of being directly coupled to each other, the push rim 510 and drive wheel 520 are connected by a transmission 560. The transmission 560 may include a drive gear/hub 550 coupled to drive wheel 520, a push rim gear/hub 570 coupled to the push rim 510, and a chain or belt 590 connected to the drive gear/hub 550 and the push rim gear/hub 570.

Again, de-coupling the fore-aft position of the push rims 510 and drive wheels 520 may allow a clinician to place the drive wheels 520 in their optimal position to provide a stable base of support 535 while still allowing the person to do “wheelies” if needed (to go over curbs and other thresholds). Also, the position of the push rims 510 can be set to promote the best positioning of the wheelchair user's shoulders. A potential aspect of this more forward positioning of the push rims 510 is a reduction in shoulder pain resulting from manual propulsion of the wheelchair. In other words, de-coupling of the push rims 510 and drive wheels 520 may allow the clinician to place the push rims 520 in front of the user's center of gravity 530 as shown in FIGS. 5A-5D, potentially improving mechanical efficiency without sacrificing wheelchair stability.

Again, the use of the transmission 560 with the belts or chains 590 may allow the wheelchair to also incorporate, into either one or both of the drive gear/hub 550 and the push rim gear/hub 570, a multi-speed fixed-gear hub such as the Sturmey-Archer S3X fixed-gear hub, for example. In such implementations, the ability to switch to higher or lower speeds may allow the wheelchair user to go faster on smooth/even terrain and to require less torque and forces on the shoulders to go up inclined terrain.

Additionally, in some implementations, the wheelchair 500 also includes a push rim repositioning member 580 that allows the push rim 510 to be repositioned to allow a user to transfer into and out of wheelchair 500 without having to lift himself over the push rim as shown in FIGS. 3A and 3B above. In the implementation shown in FIGS. 5A-5D, the repositioning member 580 is a release mechanism that allows the push rim 510 to be disconnected from the frame 505. For example, a quick release mechanism can be used to allow the push rim 510 to be removably attached to the frame 505. As shown in FIGS. 5A and 5B, the release mechanism (e.g., push rim repositioning member 580) holds the push rim 510 forward of a user's shoulders to allow propulsion of the wheelchair by the user (known as the propulsion position). As shown in FIGS. 5C and 5D, the release mechanism (e.g., push rim repositioning member 580) allows the push rim 510 to be disconnected from the frame 505, and once disconnected, the push rim 510 can be placed behind a user's shoulders to allow the user to transfer into and out of the wheelchair.

Though various aspects of this embodiment are shown in the figures and discussed above, implementations of this embodiment and application are not limited to these aspects and, accordingly, alternative implementations are discussed below.

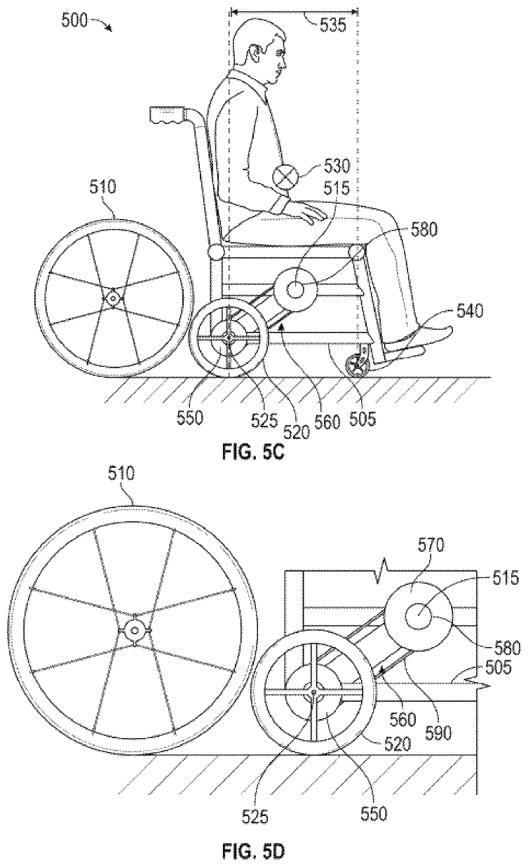

FIG. 6 is a top view illustrating an example transfer of a patient from a bed to a wheelchair according to an embodiment of the disclosure.

By incorporating a push rim reposition member, such as shown in the implementations of FIGS. 4A-4D and FIGS. 5A-5D, the wheelchair 500 can now be placed directly next to the bed 600 or other transfer surface, reducing the distance to transfer and also reducing the height to elevate the body, since the user no longer needs to clear the wheel 520 or the push rim 510 or the combination.

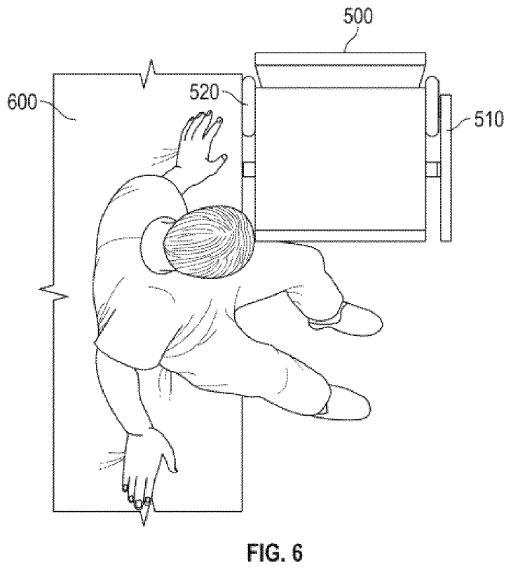

FIGS. 7A-7B are diagrams illustrating an example wheelchair with a push rim capable of being rotated backward and out of the way for transfers according to a third implementation of the present application. More specifically, FIG. 7A illustrates the wheelchair with the push rim to the wheelchair located in a propulsion position. Further, FIG. 7B illustrates the wheelchair with the push rim repositioned into a transfer position.

This implementation shown in FIGS. 7A and 7B may include features and elements similar to those discussed above with respect to the first and second implementations (of FIGS. 4A-4D and FIGS. 5A-5D). Thus, redundant descriptions thereof may be omitted. As with the implementations discussed above, in this implementation, the wheelchair 700 includes a frame 705, a rotatable push rim 710 connected to the frame 705 and a drive wheel 720 connected to the frame 705. The wheelchair 700 may also include caster wheels 740 located in front of the drive wheel 720.

As shown in FIGS. 7A-7B, the axis of rotation 725 of the drive wheel 720 is offset from the axis of rotation 715 of the push rim. Thus, instead of being directly coupled to each other, the push rim 710 and drive wheel 720 are connected by a transmission (not specifically labeled in FIGS. 7A and 7B; individual components labeled). The transmission may include a drive gear/hub 750 coupled to drive wheel 720, a push rim gear/hub 770 coupled to the push rim 710, and a chain or belt 790 connected to the drive gear/hub 750 and the push rim gear/hub 770.

Again, de-coupling the fore-aft position of the push rims 710 and drive wheels 720 may allow a clinician to place the drive wheels 720 in their optimal position to provide a stable base of support while still allowing the person to do “wheelies” if needed (to go over curbs and other thresholds). Also, the position of the push rims 710 can be set to promote the best positioning of the wheelchair user's shoulders. A potential aspect of this more forward positioning of the push rims 710 is a reduction in shoulder pain resulting from manual propulsion of the wheelchair. In other words, de-coupling of the push rims 710 and drive wheels 720 may allow the clinician to place the push rims 720 in front of the user's center of gravity as shown in FIGS. 5A-5D, potentially improving mechanical efficiency without sacrificing wheelchair stability.

Again, the use of the transmission with the belts or chains 790 may allow the wheelchair to also incorporate a multi-speed fixed-gear hub to provide the ability to switch to higher or lower speeds and thereby allow the wheelchair user to go faster on smooth/even terrain and to require less torque and forces on the shoulders to go up inclined terrain.

Additionally, in some implementations, the wheelchair 700 also includes a push rim repositioning member 780 that allows the push rim 710 to be repositioned to allow a user to transfer into and out of wheelchair 700 without having to lift himself over the push rim as shown in FIGS. 3A and 3B above. In FIGS. 7A-7B, the repositioning member 580 is a guide rail extending along the frame 705, and the push rim 710 can slide along the guide rail. Thus, the push rim 710 may be slidingly mounted to the guide rail (push rim repositioning mechanism 780) and repositioned at different portions along the length of the guide rail (push rim repositioning mechanism 780). As shown in FIGS. 7A, the push rim 710 has been slid forward (slidingly advanced in a forward direction) along the guide rail (push rim repositioning mechanism 780) to be located forward of a user's shoulders to allow the propulsion of the wheelchair by the user (known as the propulsion position). As shown in FIGS. 7B, the push rim 710 has been slid backward (slidingly advanced in a rearward direction) along the guide rail (push rim repositioning mechanism 780) to be located behind or even with a user's shoulders to allow the user to transfer into and out of the wheelchair.

Additionally, in some implementations, a locking mechanism (not shown) may be provided to releasably hold the push rim 710 (e.g., swing arm) in the propulsion position located in front of the user's shoulders as shown in FIG. 7A. Further, a second locking mechanism (not shown) or hard stop may also be provided to releasably hold or limit the rearward movement of the push rim 710 in the transfer position shown in FIG. 7B. Additionally, in some embodiments, the transmission of the wheelchair may also include an idler sprocket (not shown), which can be used to maintain a fixed tension in the belt or chain 790.

Though various aspects of this embodiment are shown in the figures and discussed above, implementations of this embodiment and application are not limited to these aspects and, accordingly, alternative implementations are discussed below.

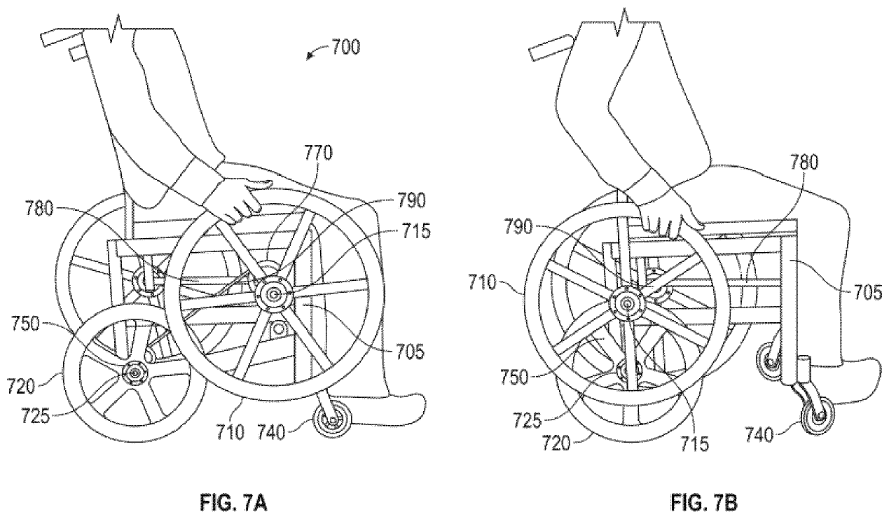

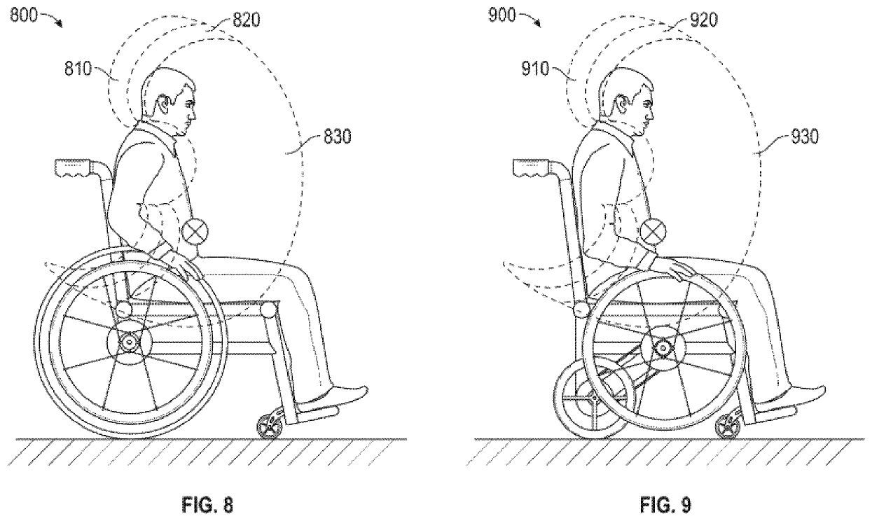

FIG. 8 illustrates the reachable workspace of a user's wrist for different shoulder ranges of motion laid over a diagram of an example wheelchair 800, and FIG. 9 illustrates the reachable workspace of a user's wrist for different shoulder ranges of motion laid over a diagram of a wheelchair 900 according to an implementation of the present application. As discussed above, a problem with conventional wheelchairs relates to the positioning of the drive wheel/push rim assembly relative to the user's shoulders. Rearward placement of the drive wheel/push rim assembly can improve stability, but such placement can require a user to continually reach backward with shoulder extension and sometimes shoulder abduction. Use of the shoulders in excessive extension and in abduction are thought to be damaging for repeated use. Also, some users may have experienced reduced range of motion that can limit the propulsive force that can be generated by the user. FIGS. 8 and 9 illustrate a hypothetical user's range of motion laid over diagrams of a wheelchair 800 and a wheelchair 900 according to an implementation of the present application. Specifically, in FIGS. 8 and 9, regions 810, 910 represent a user with a full range of motion, regions 820, 920 represent a user with a slightly reduced range of motion, and regions 830, 930 represent a reduced range of motion. As shown in FIG. 8, in order to achieve and maximize the arc of propulsion by starting the application of torque at the upper surface of the push rim of the conventional wheelchair, the user needs to take his shoulders into large angles of extension (i.e. into region 810). However, by moving the push rims forward in an implementation according to the present application, the user may be able to apply a maximum arc of propulsion with less shoulder extension (i.e. outside region 910, and into regions 920, 930).

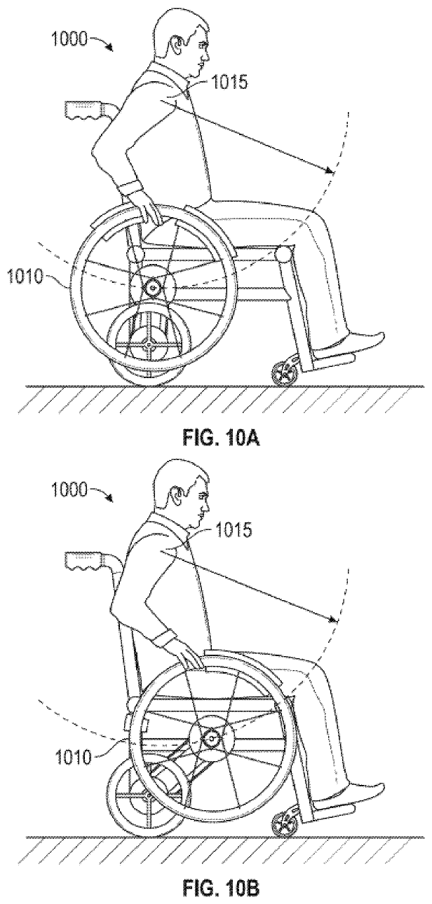

In the implementations discussed above, the push rim is shown as being movable between a propulsion position and a transfer position. However, implementations of the present invention need not have only two positions. Instead, a wheelchair according to the present application may include a push rim repositioning mechanism configured to allow customizable placement of the push rim based on a user's specific physical dimensions and/or physical capabilities and/or the activities in which the patient is involved. FIGS. 10A-10C illustrate placement of a push rim at various positions along a wheelchair according to an implementation of the present application based on a user's range of motion. FIG. 10A illustrates the push rim 1010 of the wheelchair 1000 in a position even with the user's shoulders 1015. FIG. 10B illustrates the push rim 1010 of the wheelchair 1000 rotated forward by 15 degrees with respect to the user's shoulders 1015. FIG. 10C illustrates the push rim 1010 of the wheelchair 1000 rotated forward by 15 degrees with respect to the user's shoulders 1015.

Further optional aspects of wheelchairs in accordance with embodiments disclosed herein are disclosed in U.S. Patent Publication No. 2019/0133854 to Hansen et al., filed May 5, 2015, the entirety of which is hereby incorporated by reference herein.

### Multi-Speed Configuration

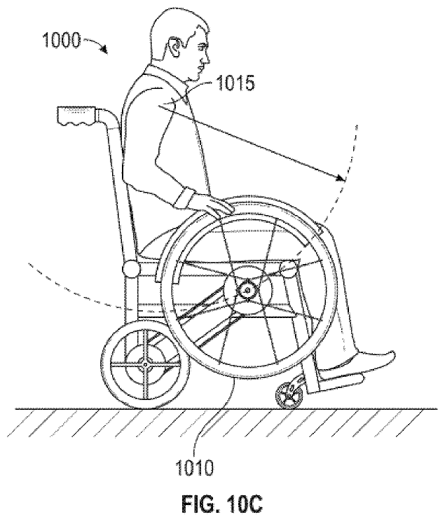

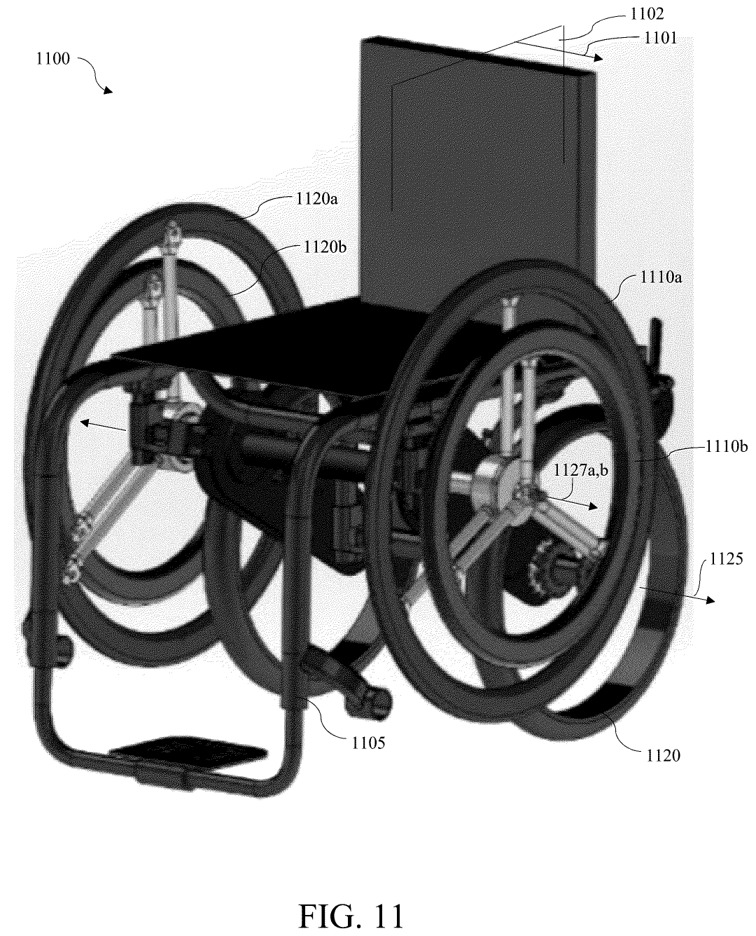

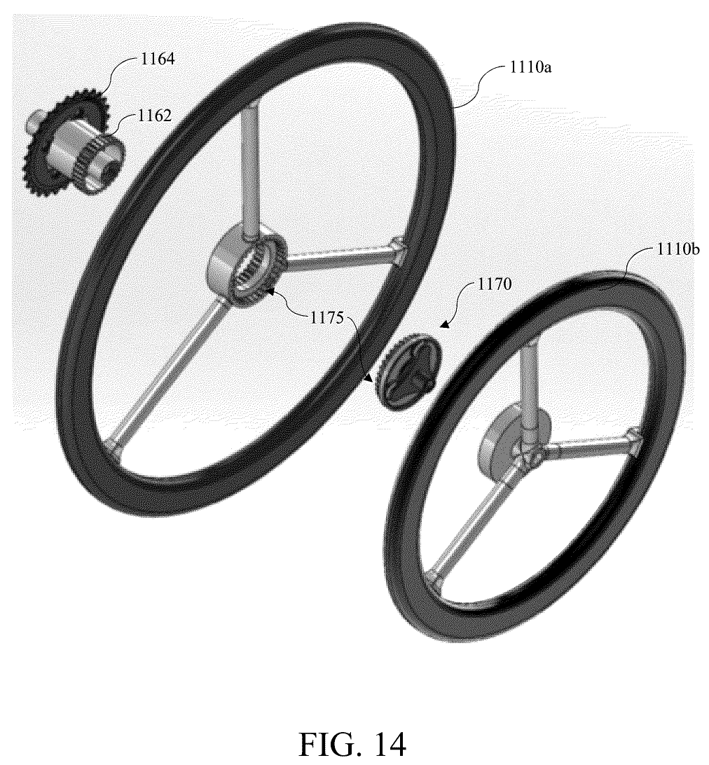

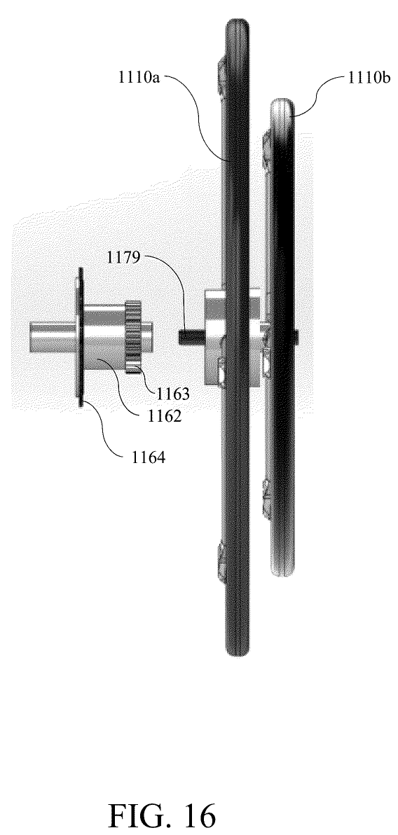

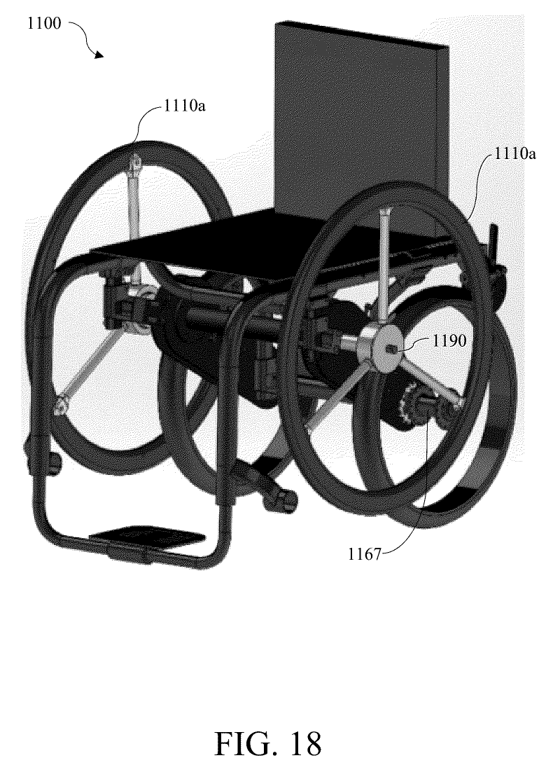

With reference to FIGS. 11-20, the wheelchairs as disclosed herein can be equipped with two push rims on each side, wherein each of the push rims provides a different torque advantage as further described herein. For example, referring to FIGS. 11 and 17, a wheelchair 1100 can comprise a frame 1105. A pair of drive wheels 1120 can be coupled to the frame 1105 and can be rotatable relative to the frame about a first axis of rotation 1125. A first push rim 1110a can be coupled to the frame 1105 on each side of the wheelchair 1100. Each first push rim 1110a can be configured to rotate relative to the frame 1105 about a second axis of rotation 1127a that extends parallel or substantially parallel to the first axis of rotation 1125. As used herein, “torque advantage” should be understood to describe the ratio between an arc length of movement of a respective push rim and the corresponding arc length of the movement of the drive wheel. Thus, a torque advantage of 1:1 should be understood to mean a first arc length of travel (e.g., one foot) of an outer circumference of a given push rim corresponding to the same first arc length of rotation (e.g., one foot) about the outer circumference of the drive wheel (and, accordingly, the same distance of travel of the drive wheel across the ground or other surface on which the wheelchair travels). A torque advantage of less than 1:1 should be understood to mean a first arc length of travel (e.g., one foot) of an outer circumference of a given push rim corresponding to a second, greater arc length of rotation (e.g., greater than one foot) about the outer circumference of the drive wheel (and, accordingly, the same distance of travel of the drive wheel across the ground or other surface on which the wheelchair travels). A torque advantage of greater than 1:1 should be understood to mean a first arc length of travel (e.g., one foot) of an outer circumference of a given push rim corresponding to a second, smaller arc length of rotation (e.g., less than one foot) about the outer circumference of the drive wheel (and, accordingly, the same distance of travel of the drive wheel across the ground or other surface on which the wheelchair travels).

A second push rim 1110b can be coupled to the frame 1105. The second push rim 1110b can be configured to rotate relative to the frame 1105 about a third axis of rotation 1127b that extends parallel or substantially parallel to the first axis of rotation 1125. Optionally, as shown in FIG. 11, the second and third axes of rotation 1127a,b can be coaxial.

As shown in FIG. 17, a transmission 1160 can be configured to transmit rotation of each of the first and second push rims 1110a,b to the corresponding drive wheel 1120 to effect rotation of the corresponding drive wheel on the respective side of the wheelchair 1100.

As stated herein, the first and second push rims 1110a,b can be configured to provide different torque advantages. For example, movement of the first push rim 1110a by a first arc length can cause the corresponding drive wheel 1120 rotatably coupled thereto to rotate by a first angular displacement, and movement of the second push rim by the first arc length can cause the corresponding drive wheel to rotate by a second angular displacement that is greater than the first angular displacement. As should be understood, an arc length can be a length along the circumference of the push rim (e.g., one foot).

Optionally, and with reference to FIG. 11, the second push rim 1110b can be positioned outwardly of the first push rim 1110a relative to an axis 1101 that extends from and perpendicularly or substantially perpendicularly to a central plane 1102 that bisects the wheelchair between the left and right sides relative to a user seated in the wheelchair. In various aspects, the first push rim 1110a can have a first diameter (e.g., first outer diameter), and the second push rim 1110b can have a second diameter (e.g., second outer diameter) that is not equal to the first diameter. For example, the diameter of the first push rim 1110a can be greater than the diameter of the second push rim 1110b. This can be advantageous in minimizing or preventing either of the push rims from interfering with operation of the other. That is, the different diameters can enable the operator to grip either one of the push rims without accidentally gripping the other.

In further aspects, it is contemplated that the different diameters of the first and second push rims 1110a,b can provide different torque advantages. For example, in some aspects, the first and second push rims 1110a,b can be fixedly coupled to each other so the first push rim does not rotate relative to the second push rim. As used herein, “fixedly coupled” should be understood to describe an arrangement in which a first component is coupled to or associated with a second component so that rotation of the first component by an angular displacement causes corresponding rotation of the second component by the same angular displacement. Such arrangements can include any direct or indirect mechanical connection or linkage that ensures that rotation and angular displacement of the first component effects a corresponding rotation of the second component by the same angular displacement. Accordingly, a user pushing the push rim having the larger diameter (e.g., the first push rim) by a first arc length can cause the corresponding drive wheel to rotate by a first angular displacement, whereas the user pushing the push rim having the smaller diameter (e.g., the second push rim) by the same arc length can cause the drive wheel to move by a second arc length that is greater than the first arc length.

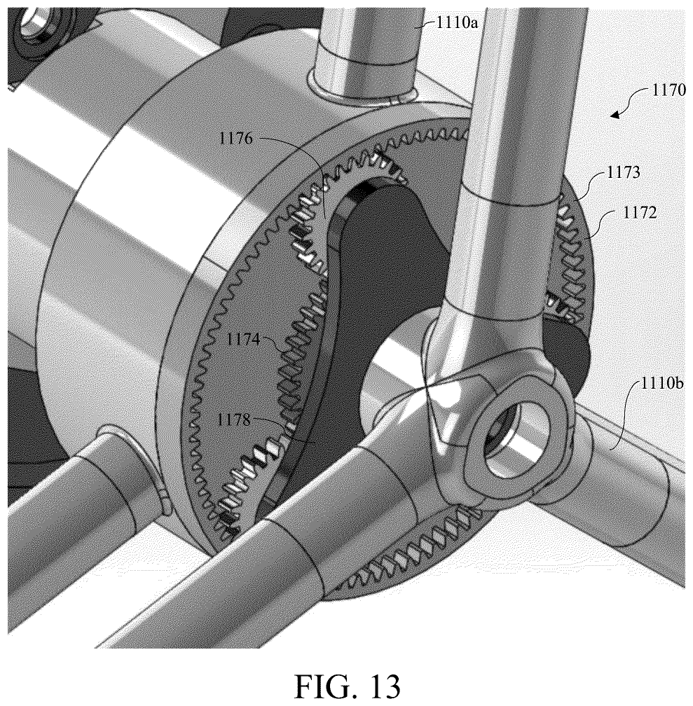

Referring to FIGS. 11-16, in further optional aspects, the wheelchair 1100 can comprise a gear system 1170 that couples first push rim 1110a to the second push rim 1110b to provide a torque advantage between the first and second push rims 1110a,b. For example, the gear system 1170 can comprise epicyclic gearing (e.g., a planetary gear train). The gear system 1170 can comprise a sun gear 1174, a ring gear 1172 that is coaxial with the sun gear, at least one planetary gear 1176 (e.g., optionally, a plurality of planetary gears, such as three planetary gears) operatively disposed between and in engagement with the sun gear and the ring gear, and a carrier 1178 that is coupled to the at least one planetary gear and coaxial with the sun gear. In some optional aspects, the first push rim 1110a can define or comprise the ring gear 1172. For example, inner teeth can be formed into a portion of the first push rim 1110a, or a body 1173 defining inner teeth can be a component of the first push rim 1110a and interface with the rest of the first push rim via a spline coupling 1175 as shown in FIG. 14. The second push rim 1110b can be fixedly coupled to the carrier 1178. The sun gear 1174 can be fixedly coupled to the frame (e.g., via a spline 1179) so that the sun gear cannot rotate. The gear system 1170 can optionally be at least partially covered or at least partially enclosed to allow lubrication (e.g., grease).

Such a configuration, with first push rim 1110a comprising the ring gear 1172 and the carrier 1178 coupled to the second push rim 1110b, can provide a gear ratio between the first push rim 1110a and second push rim 1110b of about 1:1 to about 1:2. For example, in some optional aspects, the gear system can provide a ratio of 2:3 so that a rotation of the second push rim corresponds to 1.5 rotations of the first push rim. It is further contemplated that first push rim 1110a can comprise the ring gear 1172, and the sun gear 1174 can be coupled to the second push rim 1110b, with the carrier 1178 fixedly coupled to the frame. It is contemplated that this configuration can provide a gear ratio between the first push rim 1110a and second push rim 1110b of less than or equal to 1:2 (optionally, about 1:4). That is, the described gear configuration can provide gearing in which the second push rim rotates at least two rotations for each rotation of the first push rim.

In various aspects, the first push rim 1110a can rotate relative to the drive wheel 1120 at a ratio of about 1:1 (revolution to revolution). In still further aspects, the second push rim 1110b can rotate relative to the drive wheel at a ratio of about 1:1 (revolution to revolution). In yet further aspects, the second push rim 110b can rotate relative to the drive wheel 1120 at a ratio of about 2:3 (revolution to revolution). In various aspects, each of the first push rim 1110a and the second push rim 1110b can rotate relative to the drive wheel 1120 at a ratio of between 3:1 and 3:5 (revolutions to revolutions). For example, optionally, the first push rim 1110a can rotate relative to the drive wheel 1120 at a ratio of between about 1:1 and about 3:5, and the second push rim 1110b can rotate relative to the drive wheel at a ratio of between about 3:1 and about 1:1. In still further aspects, the first and second push rims 1110a, 1110b can couple to the drive wheel 1120 with respective torque advantages. In some aspects, the torque advantage of the first push rim 1110a can be greater than the torque advantage of the second push rim 1110b. In some optional aspects, the first push rim 1110a can couple to the drive wheel 1120 with a torque advantage of greater than 1:1. In some optional aspects, the second push rim 1110b can couple to the drive wheel 1120 with a torque advantage of less than 1:1. With these different torque advantages, the higher torque advantage (the first push rim) can facilitate movement over difficult terrain, movement uphill, acceleration from a stop, and other movements that require high torque, whereas the lower torque advantage (second push rim) can be used across easier terrain, downhill, or after the wheelchair has begun movement. Accordingly, the user can initially start from a stop by pushing the first push rim 1110a and can then switch to the second push rim 1110b to maintain momentum. In still further aspects, the second push rim 1110b can advantageously be used to provide additional resistance for exercise.

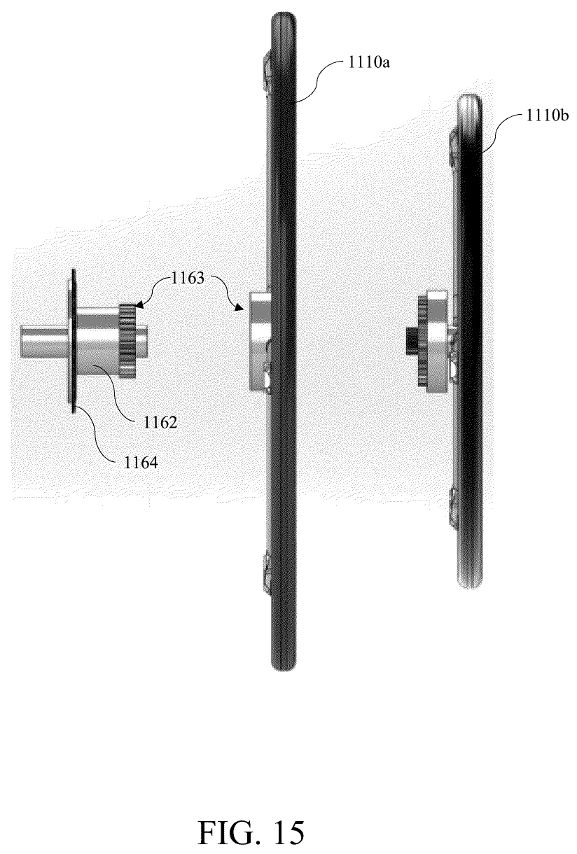

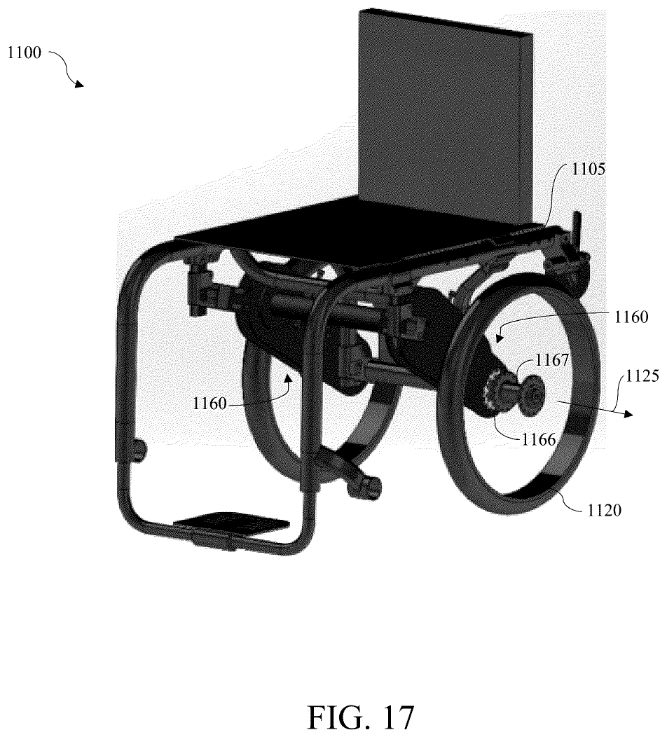

Referring to FIGS. 16, 17, and 19, it is contemplated that the transmission 1160 can comprise a chain and sprocket coupling. For example, the first push rim 1110a can be fixedly coupled to an axle 1162 (e.g., via a spline coupling 1163). A push rim sprocket 1164 can be fixedly coupled to the axle 1162 (e.g., via keyed or spline coupling). A corresponding drive wheel sprocket 1166 can be fixedly coupled to the drive wheel 1120 (optionally, via an axle 1167 (FIG. 18) that is fixedly coupled to the drive wheel 1120). A chain 1168 can extend about and between the push rim sprocket 1164 and the drive wheel sprocket 1166.

In some optional aspects, the push rim sprocket 1164 and the drive wheel sprocket 1166 can provide a torque advantage. For example, the pair of sprockets can provide a sprocket ratio (i.e., the ratio of the teeth of the push rim sprocket to the number of teeth of the drive wheel sprocket) that is greater than, less than, or equal to one, depending on the desired torque advantage to be provided.

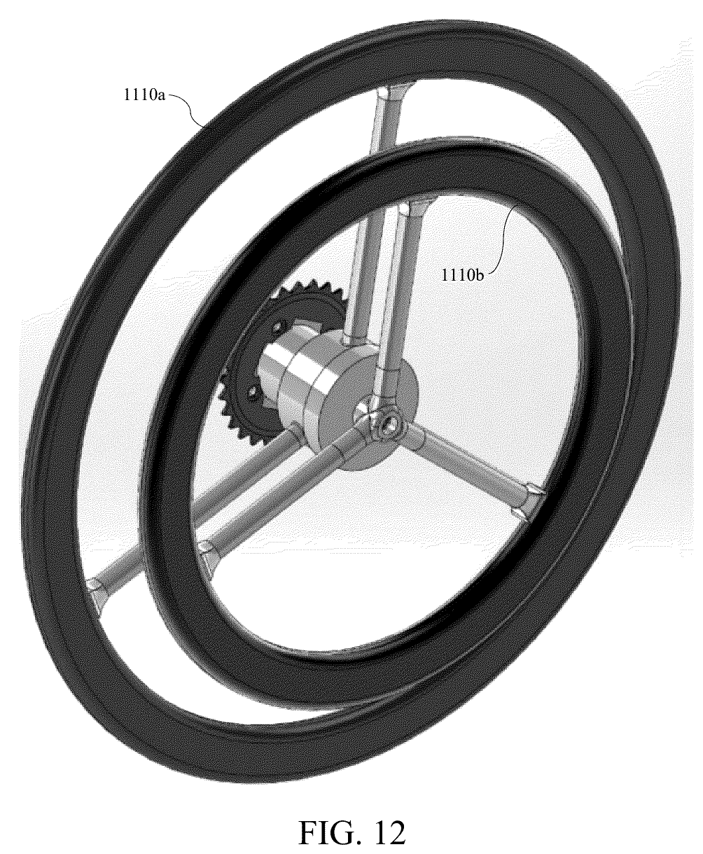

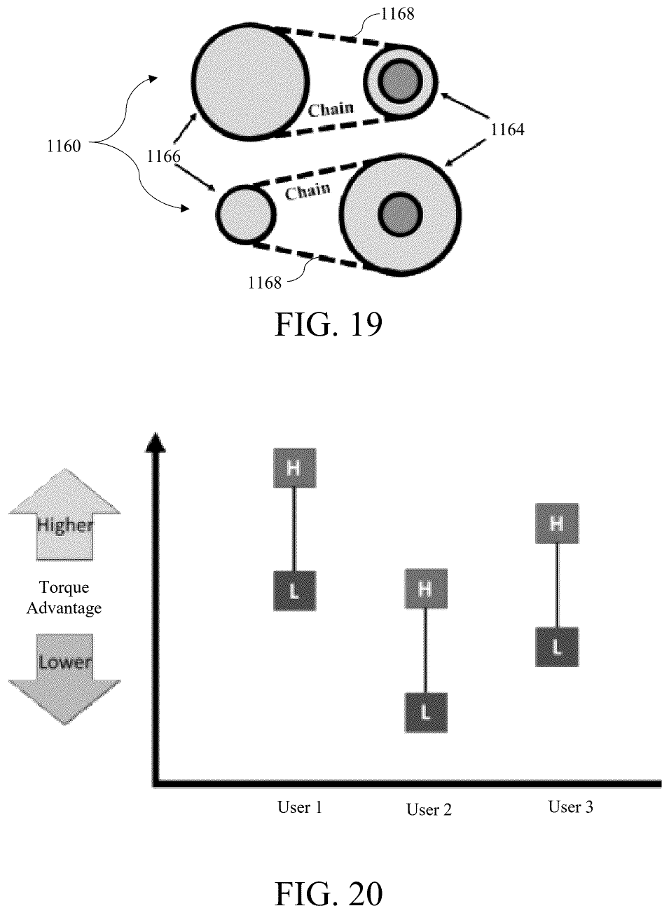

Referring also to FIG. 20, it is further contemplated that the sprocket ratio of the push rim sprocket 1164 and the drive wheel sprocket 1166 can be adjustable to tailor the torque advantage for a particular user or environment (e.g., indoors or outdoors, carpet or tile floor, flat or hilly landscape). For example, by changing one or both of the push rim sprocket 1164 and the drive wheel sprocket 1166, the torque advantage of both the first and second push rims 1110a,b can be altered to tailor the torque advantage for a particular user. Thus, for example, stronger users can be provided with a higher torque advantage (so that fewer rotations of the push rims correspond to greater movement of the wheelchair), whereas less strong users can be provided with a lower torque advantage. Accordingly, a first user can use a configuration providing a first pair of torque advantages corresponding to the first and second push rims; a second user can use a configuration providing a second pair of torque advantages (that can be different than the first pair of torque advantages); and a third user can use a third configuration having a third pair of torque advantages (that can be different than the first and second pairs of torque advantages). In some aspects, at least one sprocket can be configured for replacement and removal. For example, a spline coupling 1163 can enable rapid removal and replacement of the entire axle 1162 (with the sprocket 1164 coupled thereto). In further aspects, the sprocket 1164 can couple to the axle 1162 via fasteners that can be removed to replace the sprocket 1164 with a second sprocket having a different number of teeth. This can provide for low-cost adjustment to the torque advantage, as compared to, for example adjusting the gear ratio of the gear system 1170 (FIG. 13). Optionally, the sprocket can be swapped out while the user is seated in the wheelchair, thereby enabling the user to instantly try the torque advantage associated with the new sprocket. In some aspects, a kit can comprise a wheelchair 1100 as described herein and at least one additional sprocket (beyond the sprockets being used in the initial configuration) that is configured to replace one of the push rim sprocket 1164 or the drive wheel sprocket 1166 to adjust the sprocket ratio.

It is contemplated that the overall torque advantage of the push rims can be determined as the ratio of (a) the rotation of a push rim by a given arc length to (b) the arc length of the rotation of the corresponding drive wheel. Accordingly, if the first push rim 1110a has a diameter that is 1.5 times the size of the drive wheel, and the sprocket ratio between the first push rim and the drive wheel is 1:1, the overall torque advantage of the first push rim is 1.5, so that pushing the first push rim by an arc length of 1.5 feet causes the drive wheel to rotate with an arc length of 1 foot. If the sprocket ratio is not 1:1, the torque advantage can be multiplied by the sprocket ratio. Thus, for a sprocket ratio in which the push rim sprocket 1164 has twice the number of teeth as the drive wheel sprocket 1166, the sprocket ratio can be 1:2. Thus, if the first push rim 1110a has a diameter that is 1.5 times the size of the drive wheel, and the sprocket ratio is 1:2, then the overall torque advantage of the first push rim can be 0.75. That is, pushing the first push rim by an arc length of 0.75 feet causes the drive wheel to rotate with an arc length of 1 foot. Accordingly, for the embodiment shown in FIGS. 11-16, the overall torque advantage of the first push rim, TA1, can be calculated as

$$TA 1 = \frac{D\_PR1}{D\_DW} * \frac{n\_s 1}{n\_s 2} ,$$

where D_PR1 is the diameter of the push rim, D_DW is the diameter of the drive wheel, n_s1 is the number of teeth on the drive wheel sprocket, and n_s2 is the number of teeth on the push rim sprocket.

For embodiments in which the second push rim is coupled to the first push rim by a gear system, the torque advantage of the second push rim, TA2 can be calculated as

$$TA 2 = \frac{D\_PR2}{D\_DW} * \frac{{n}_{s 1}}{{n}_{s 2}} * GR ,$$

wherein where D_PR2 is the diameter of the push rim, D_DW is the diameter of the drive wheel, n_s1 is the number of teeth on the drive wheel sprocket, n_s2 is the number of teeth on the push rim sprocket, and GR is the gear ratio between the first push rim and the second push rim. Thus, for example, if the gear ratio of the first push rim to the second push rim is 2:3, with the sprocket ratio of 1:2, and with the second push rim having a diameter equal to 0.8 times the diameter of the drive wheel, the torque advantage of the second push rim can be 0.8*1/2*2/3, or 0.267.

Referring to FIGS. 11, 17, and 18, it is contemplated that the second push rim 1110b can be removable. For example, the second push rim 1110b can couple to the gear system 1170, and the gear system 1170 can rotatably couple to the first push rim 1110a via spline coupling 1175. A retainer pin (not shown) can extend perpendicularly or substantially perpendicularly to the third rotational axis 1127b of the second push rim to axially retain the second push rim. The retainer pin can optionally be a ball lock pin (e.g., a pin comprising one or more ball detents). The retainer pin can easily be removed, and the second push rim 1110b and gear system 1170 can axially slide outwardly along the splines for removal. In further aspects, in addition to or instead of the retainer pin, other retaining elements, such as threaded couplings, press-fit elements, etc. are contemplated for axially retaining the second push rim in engagement with the first push rim. In this way, the overall weight of the wheelchair can be reduced (by eliminating the second push rims 1110b and gear systems 1170). Further, removal of the second push rims 1110b can reduce the width of the wheelchair relative to the axis 1101, thereby allowing for movement in narrow passages or through narrow doors. Optionally, with the second push rim 1110b removed, a lightweight cover and pin 1190 can retain the first push rim on the wheelchair. It is further contemplated that the first push rims 1110a can be removable. In this way, the user can more easily get into and out of the wheelchair. Further, with the first push rims 1110a removed, the wheelchair can further reduce the width of the wheelchair relative to the axis 1101, thereby allowing for movement in narrow passages or through narrow doors. Still further, with the first push rims 1110a removed, the wheelchair can be configured for transport (e.g., packed in a trunk of a vehicle).

It is contemplated that the wheelchair 1100 can weigh less than 29 pounds, thereby qualifying as an ultralight wheelchair. In further aspects, the wheelchair 1100 can weigh less than 35 pounds (e.g., 34 pounds). Optionally, the wheelchair 1100 can weigh less than 35 pounds (e.g., 34 pounds) with both sets of first and second push rims 1110a,b attached, and the wheelchair can weigh less than 29 pounds with only the pair of first push rims 1110a attached (and the second push rims 1110b removed).

Although not shown in the Figures, it is further contemplated that the epicyclic gearing can be positioned so that the ring gear is coaxial with the drive wheel, and the first and second push rims 1110a,b can couple to the epicyclic gearing via, for example, respective sprockets and belts or chains.

In still further aspects, it is contemplated that the gear system 1170 can be omitted. Rather, the first and second push rims 1110a,b can drive respective axles that can be coaxial. Each axle can be coupled to a respective sprocket. Each of the sprockets of the axles of the first and second push rims 1110a,b can be coupled to a respective sprocket that is fixedly coupled to the axle of the drive wheel. The ratio of the number of teeth of the sprocket of the axle of the first push rim 1110a to the teeth of the respective sprocket of the axle can be different from the ratio of the number of teeth of the sprocket of the axle of the second push rim 1110b to the teeth of the respective sprocket of the axle. In this way, the first and second push rims 1110a,b can rotate at different angular rates relative to each other. Accordingly, it is contemplated that the cost and complexity of gearing can be avoided. However, omission of gears in favor of separate sprockets for each push rim can, in some circumstances, add to the weight of the wheelchair.

Although the foregoing wheelchair, systems, and methods have been described in some detail by way of illustration and example for purposes of clarity of understanding, certain changes and modifications may be practiced within the scope of the appended claims.

What is claimed is:

1. A wheelchair comprising:
a frame;
a drive wheel coupled to the frame, wherein the drive wheel is configured to rotate relative to the frame about a first axis of rotation;
a first push rim coupled to the frame, wherein the first push rim is configured to rotate relative to the frame about a second axis of rotation that extends parallel or substantially parallel to the first axis of rotation;
a second push rim coupled to the frame, wherein the second push rim is configured to rotate relative to the frame about a third axis of rotation that extends parallel or substantially parallel to the first axis of rotation;
a transmission configured to transmit rotation of each of the first and second push rims to the drive wheel to cause rotation of the drive wheel,
wherein movement of the first push rim by a first arc length is configured to cause the drive wheel to rotate by a first angular displacement, wherein movement of the second push rim by the first arc length is configured to cause the drive wheel to rotate by a second angular displacement that is greater than the first angular displacement,
wherein the first push rim is coupled to the second push rim so that rotation of the first push rim by a third angular displacement causes rotation of the second push rim by a fourth angular displacement that is not equal to the third angular displacement.

2. The wheelchair of claim 1, wherein the second and third axes of rotation are coaxial.

3. The wheelchair of claim 1, wherein the first push rim has a first diameter, wherein the second push rim has a second diameter that is not equal to the first diameter.

4. The wheelchair of claim 3, wherein the second diameter is less than the first diameter.

5. The wheelchair of claim 3, wherein the first push rim is inwardly positioned relative to the second push rim along the first axis of rotation.

6. The wheelchair of claim 1, wherein the first push rim is coupled to the second push rim by an epicyclic gear train comprising: a sun gear, a ring gear that is coaxial with the sun gear, at least one planetary gear disposed between the sun gear and the ring gear, and a carrier that is coupled to the at least one planet gear and coaxial with the sun gear.

7. The wheelchair of claim 6, wherein:
the first push rim defines the ring gear, and
the second push rim is fixedly coupled to the carrier.

8. The wheelchair of claim 6, wherein the first push rim is configured to rotate relative to the drive wheel at a ratio of between 3:1 to 3:5.

9. The wheelchair of claim 7, wherein the second push rim is configured to rotate relative to the drive wheel at a ratio of between 3:1 to 3:5.

10. The wheelchair of claim 6, wherein one of the first push rim or the second push rim is configured rotate relative to the drive wheel at a ratio of 1:1.

11. The wheelchair of claim 1, wherein the second axis of rotation of the push rim is offset from the first axis of rotation of the drive wheel in a direction orthogonal to the first axis of rotation of the drive wheel.

12. The wheelchair of claim 11, wherein the transmission comprises a pair of sprockets and a belt or chain extending between the pair of sprockets.

13. The wheelchair of claim 12, wherein the pair of sprockets comprises a first sprocket that is fixedly coupled to the first push rim and a second sprocket that is fixedly coupled to the drive wheel.

14. The wheelchair of claim 12, wherein the pair of sprockets define a sprocket ratio that is equal to 1.

15. The wheelchair of claim 12, wherein the pair of sprockets define a sprocket ratio that is not equal to 1.

16. The wheelchair of claim 12, wherein at least one sprocket of the pair of sprockets is configured for removal and replacement.

17. The wheelchair of claim 1, wherein the second push rim is positioned outwardly of the first push rim relative to an axis that extends from and perpendicularly to a central plane that bisects the wheelchair.

18. A method of using the wheelchair of claim 1, the method comprising:
pushing the first push rim to propel the wheelchair; and
pushing the second push rim with the wheelchair in motion while the wheelchair has momentum from pushing the first push rim.

19. A kit comprising:
a wheelchair comprising:
a frame;
a drive wheel coupled to the frame, wherein the drive wheel is configured to rotate relative to the frame about a first axis of rotation;
a first push rim coupled to the frame, wherein the first push rim is configured to rotate relative to the frame about a second axis of rotation that extends parallel or substantially parallel to the first axis of rotation;
a second push rim coupled to the frame, wherein the second push rim is configured to rotate relative to the frame about a third axis of rotation that extends parallel or substantially parallel to the first axis of rotation;
a transmission configured to transmit rotation of each of the first and second push rims to the drive wheel to cause rotation of the drive wheel, wherein the transmission comprises a pair of sprockets and a belt or chain extending between the pair of sprockets, wherein at least one sprocket of the pair of sprockets is configured for removal and replacement,
wherein movement of the first push rim by a first arc length is configured to cause the drive wheel to rotate by a first angular displacement, wherein movement of the second push rim by the first arc length is configured to cause the drive wheel to rotate by a second angular displacement that is greater than the first angular displacement,
wherein the first push rim is coupled to the second push rim so that rotation of the first push rim by a third angular displacement causes rotation of the second push rim by a fourth angular displacement that is not equal to the third angular displacement; and
at least one additional sprocket that is configured to replace one sprocket of the pair of sprockets, wherein the additional sprocket has a different number of teeth than the one sprocket of the pair of sprockets.
